(19) United States
(12) Patent Application Publication
(10) Pub. No.: US 2003/0095677 A1
(43) Pub. Date: May 22, 2003

(54) Aural aid

(76) Inventor: Takeshi Takeda, Tokyo (JP)

Correspondence Address: BROWDY AND NEIMARK, P.L.L.C., 624 NINTH STREET, NW, SUITE 300, WASHINGTON, DC, 20001-5303, US

(21) Appl. No.: 10/181,716

(22) PCT Filed: Nov. 16, 2001
(86) PCT No.: PCT/JP01/10010

(51) Int. Cl. H04R 25/00

(52) U.S. Cl. 381/326; 381/380

(57) ABSTRACT

It is intended to provide a hearing aid adapted to primarily listen to a desired sound when a person suffering from some impairment in hearing ability makes conversation to others or in watching television. The hearing aid is constructed of: a main body portion provided with a microphone, an amplifier and a driving battery; and, a speaker portion constructed of a bone conduction speaker connected with the main body portion. In a preferable form of the bone conduction speaker: a yoke is provided with a central magnetic pole surrounded by a voice coil; the yoke extend in four directions to form extensions, a pair of diametrically opposing ones of which have each of magnets mounted on each of the pair. Each of the remaining pair of the extensions is provided an upright support portion for fixedly supporting a diaphragm; and, the diaphragm is fixedly mounted on the support portions.

### FIELD OF THE INVENTION

The present invention relates to a hearing aid, and more particularly to a hearing aid adapted to be used by a person suffering from some impairment in his or her hearing ability in making conversation to others or in watching television, or by a person who is normal in hearing ability in making conversation to others in a noisy environment, wherein the hearing aid is compact in size and employs a high-performance bone conduction speaker.

### BACKGROUND OF THE INVENTION

Heretofore, a person suffering from some impairment in his or her hearing ability must rely on a conventional hearing aid when he or she makes conversation to others or watches television. In general, the conventional hearing aid is of an air conduction type, and therefore mounted on a user's ear in use. Consequently, the conventional hearing aid is not adequate for the purpose of hearing only a desired one of voice sounds when a user makes conversation to a desired person or watches television to hear a desired one of sounds issued from a television set.

As described above, heretofore, there is not known any hearing aid adapted to be used by a person suffering from some impairment in his or her hearing ability for receiving primarily a desired one of sounds in conversation or in watching television. Therefore, it is an object of the present invention to provide a hearing aid adapted to be used under such circumstances. More specifically, it is an object of the present invention to provide a hearing aid, which is compact in size, excellent in both performance and strength and employs a bone conduction speaker.

### SUMMARY OF THE INVENTION

The above object of the present invention is accomplished by providing a hearing aid comprising: a main body portion provided with a microphone, an amplifier and a driving battery; and, a speaker portion constructed of a bone conduction speaker electrically connected with said main body portion. As such a bone conduction speaker used here, it is preferable to use a bone conduction speaker comprising: a yoke provided with a central magnetic pole on which a voice coil is coaxially mounted, wherein the yoke extends in four directions to have their extensions classified into two pairs of diametrically opposing extensions, one pair of which pairs is constructed of the extensions each provided with a magnet, the other pair being constructed of the extensions each provided with an upright support portion for supporting a diaphragm, wherein the diaphragm is fixedly mounted on the diametrically opposing pair of the upright support portions of the yoke.

### BRIEF DESCRIPTION OF THE DRAWING

FIG. 1 is a view illustrating the hearing aid of the present invention as a whole. FIG. 2 is a view illustrating another embodiment of the speaker portion according to the present invention in construction. FIG. 3 is further another embodiment of the speaker portion according to the present invention in construction. FIG. 4 is a longitudinal sectional view of a housing in which the bone conduction speaker adapted to be employed in the present invention is incorporated. FIG. 5 is a longitudinal sectional view of the bone conduction speaker adapted to be used in the present invention. FIG. 6 is a longitudinal sectional view taken along a line perpendicular to the line along which the longitudinal sectional view of FIG. 5 is taken, illustrating the bone conduction speaker adapted to be used in the present invention. FIG. 7 is a plan view of the bone conduction speaker adapted to be used in the present invention, provided that the diaphragm is removed. And, FIG. 8 is a plan view of the diaphragm of the bone conduction speaker adapted to be used in the present invention.

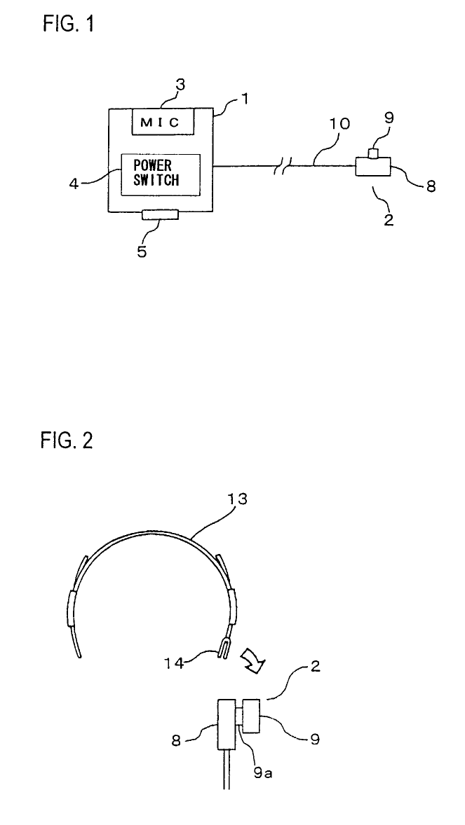

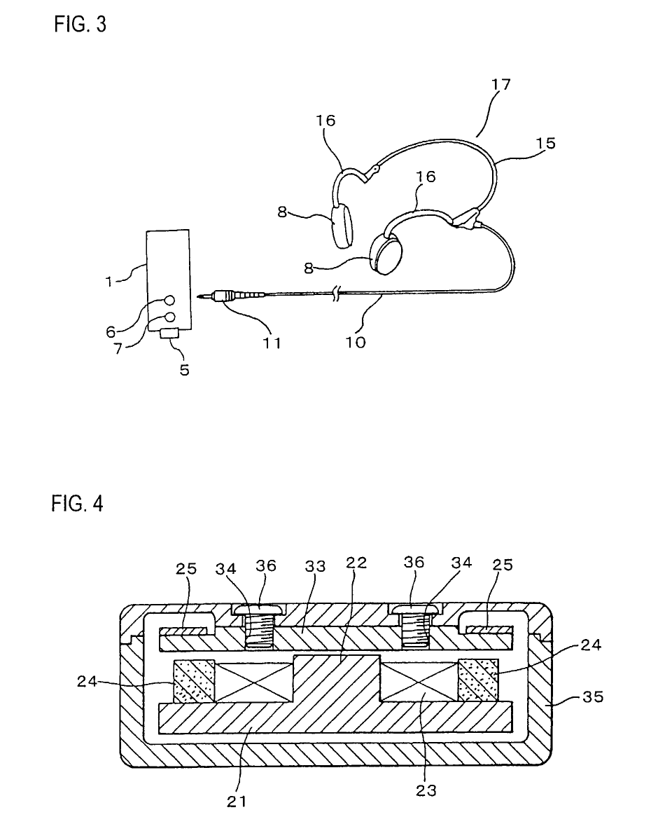

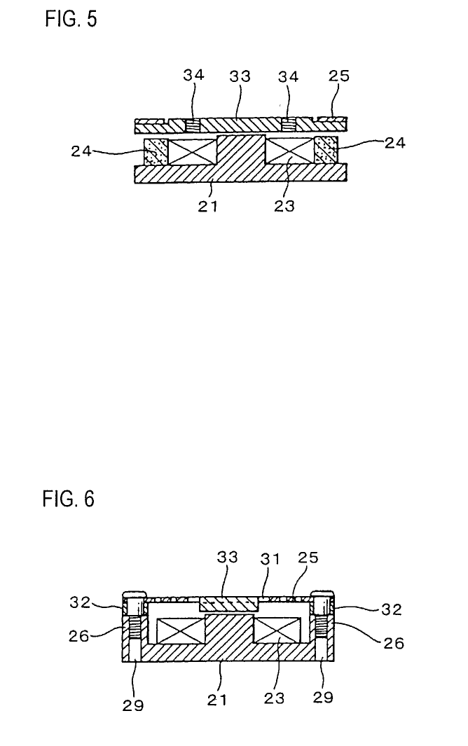

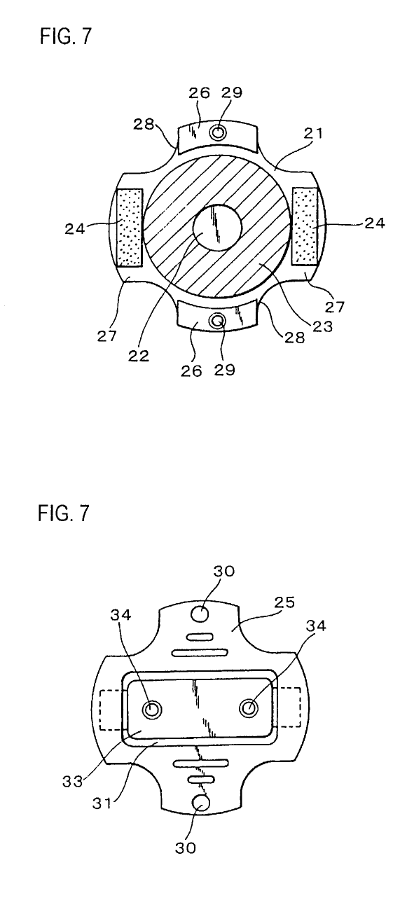

### BEST MODE FOR CARRYING OUT THE INVENTION

With reference to the accompanying drawings, an embodiment of the present invention will be described. A hearing aid of the present invention is constructed of a main body portion 1 and a speaker portion 2, which is electrically connected with the main body portion 1.

The main body portion 1 is provided with a microphone 3, a power switch 4, a volume knob 5 and like components. Further, incorporated in the main body portion 1 are an amplifier and a driving battery for driving these components. A speaker cable connecting terminal 6 is mounted on a side surface of the main body portion 1. Preferably, an audio cable connecting terminal 7 is further provided in the hearing aid (see FIG. 3).

The speaker portion 2 is constructed of: a bone conduction speaker 8; a grip portion 9 projecting outward from a side surface of the bone conduction speaker 8; and, a cable 10 for electrically connecting the speaker portion 2 with the main body portion 1 through a connector 11 which is inserted into the speaker cable connecting terminal 6.

The other end of the audio cable connected with the audio cable connecting terminal 7 is connected with an audio output terminal of an audio output unit. It is needless to say that the audio cable is inputting means for inputting an audio signal, which is issued from an audio output unit, to the main body portion 1. Such an audio output unit comprises any output unit issuing a sound signal such as a voice sound signal, an audio signal and like signals from its audio output terminal, wherein the output unit may be any one of a television set, a CD player, a broadcasting radio receiver and like output units.

In use, the user may hold the speaker portion 2 through its grip portion 9. It is also possible for the user to wear the speaker portion 2 through a headband, which enables the user to use both hands in a free manner. In other words, such a headband 13 is provided with an insertion opening 14 in which a shaft portion 9a of the grip portion 9 is mounted in an insertion manner (see FIG. 2).

Further, it is also possible to provide a head set 17 in place of the speaker portion 2. In this case, the head set 17 is provided with a bone conduction speaker 8 in at least one of its ear engaging portions 16. The ear engaging portions 16 are provided in opposite ends of a curved member 15 fitted to the back of the user's head (see FIG. 3). Further, it is also possible to mount the speaker portion 2 on a temple member of eyeglasses (although the speaker portion 2 is mounted on an end portion of the temple member, it is also possible to mount the speaker portion 2 on an intermediate portion of the temple member). In this case, it is preferable to detachably mount the speaker portion 2 on the temple member.

Next, the bone conduction speaker 8 adapted to be used in the present invention and shown in FIGS. 4 to 8 will be described. The bone conduction speaker 8 is constructed of: a yoke 21 provided with a central magnetic pole 22; a pair of diametrically-opposing divided magnets 24 disposed outside a doughnut-type voice coil 23 which surround the central magnetic pole 22; and, a vibrating board or diaphragm 25 mounted on a pair of diametrically opposing upright support portions 26 of the yoke 21.

The yoke 21 is slightly larger than the voice coil 23, and provided with four extensions each radially outwardly extending in each of four directions. One pair of the four extensions form a pair of diametrically opposing magnet support portions 27, 27. The remains of the extensions form a pair of diametrically opposing upright support portions 28, 28 for supporting the diaphragm 25. Fixedly mounted on each of the magnet support portions 27, 27 is the magnet 24, which assumes a rectangular parallelepiped shape disposed adjacent to the voice coil 23. Each of the magnet support portions 27 may assume a curved shape extending along the voice coil 23.

Each of the diaphragm support portions 26, 26 assumes an upright shape, and is integrally formed with each of the upright support portions 28, 28 and provided with a blind hole 29 in its center. The blind hole 29 is used to fixedly mount the diaphragm 25 on the yoke 21. As shown in FIG. 8, the diaphragm 25 has four extensions each radially outwardly extending in each of four directions. As viewed in FIG. 8, an upper and a lower one of the extensions of the diaphragm 25 are provided with an upper and a lower through-hole 30, respectively. Each of these through-holes 30, 30 corresponds in position to each of the blind holes 29. Also as viewed in FIG. 8, the diaphragm 25 is provided with a central elongated opening 31 laterally extending in its central area. The diaphragm 25 is fixedly mounted on the diaphragm support portions 26, 26 through screws.

Mounted on the diaphragm 25 is a plate yoke 33. This plate yoke 33 extends along the central opening 31, has its thick wall portion positioned within the central opening 31 and has an upper surface of this thick wall portion be flash with an upper surface of the diaphragm 25. For example, the plate yoke 33 has its opposite thin wall portions fixedly mounted on a rear surface of the diaphragm 25 by suitable fastening means such as soldering and the like. In other words, the plate yoke 33 has only its opposite thin wall portions fixedly mounted on the diaphragm 25 to permit its central thick wall portion to freely vibrate in a position corresponding to the central opening 31 of the diaphragm 25.

In general, the central thick wall portion of the plate yoke 33 is provided with a pair of tapped holes 34 which is threadably engaged with a pair of screws 36 when the plate yoke 33 is incorporated in a housing 35. After completion of such threadable engagement of the screws 36 with the tapped holes 34, the speaker 37 is entirely mounted in the housing 35. The housing 35 may be divided into an upper and a lower half.

In an assembling operation, the bone conduction speaker 37 is mounted in the housing 35 through the plate yoke 33 in a floating manner. Consequently, vibration caused by a voice sound or by application of an audio input signal may be effectively transmitted to the housing 35, which may realize the bone conduction speaker 37 excellent in efficiency. Furthermore, in construction of this embodiment, the magnets 24 are divided ones (in contrast with the conventional magnet assuming a circular shape an outer surface of which is surrounded by a casing), and coaxially disposed so as not to extend radially outwardly. This enables the bone conduction speaker 37 of this embodiment to be compact in size.

In use of the hearing aid of the present invention in making conversation to a conversation partner, it is necessary for the user to hand the partner the main body portion 1 and have the partner talk to the microphone 3 of the main body portion 1. At the same time, it is necessary for the user to have the bone conduction speaker 8 brought into slight contact with the user's temple or its vicinities by using the grip portion 9 and select a favorable contact area in which the user may most effectively pick up the transmitted voice sound through the bone conduction speaker 8. At this time, the user may control the transmitted voice sound in volume by turning the volume control knob 5 of the main body portion 1.

In watching television, one of opposite end portions of the audio cable is electrically connected with the audio cable connecting terminal 7 in a condition in which the other of the opposite end portions is electrically connected with an audio output terminal which is generally provided in a rear side of a television set. After that, as is in the case described above, the user wears the bone conduction speaker 8 on his head. More specifically, through the headband 13, the head set, or the temple member of the eyeglasses, the bone conduction speaker 8 is brought into slight contact with the user's head.

### INDUSTRIAL APPLICABILITY

The present invention has the construction described above. Consequently, the present invention is adapted to be used by a person suffering from some impairment in hearing ability when he or she makes conversation to others or watches television. The present invention is also adapted to be used by persons each normal in hearing ability when they make conversation to each other in a noisy environment.

1. A hearing aid comprising: a main body portion provided with a microphone, an amplifier and a driving battery; and, a speaker portion constructed with a bone conduction speaker connected with said main body portion.

2. The hearing aid as set forth in claim 1, wherein said main body portion is provided with an audio cable connecting terminal.

3. The hearing aid as set forth in claim 1 or 2, wherein said speaker portion is constructed of a bone conduction speaker provided with a grip portion extending outward.

4. The hearing aid as set forth in claim 3, wherein said speaker portion is constructed of a bone conduction speaker mounted on an end portion of a headband.

5. The hearing aid as set forth in claim 1, wherein: a curved member is provided with a pair of temple members each provided in each of opposite end portions of said curved member; and, said speaker portion is constructed of a bone conduction speaker mounted on one or each of said temple members of said curved member.

6. The hearing aid as set forth in claim 1, wherein said speaker portion is detachably mounted on a temple member of eyeglasses.

7. The hearing aid as set forth in claim 1, wherein: said bone conduction speaker is provided with a yoke which has its central magnetic pole surrounded by a voice coil; said yoke extends in four directions to form four extensions; each of a pair of diametrically-opposing ones of said extensions carries a magnet; and, each of the remaining pair of diametrically-opposing ones of said extensions is provided with an upright support portion for supporting a diaphragm; and, said diaphragm is fixedly mounted on said upright support portion for supporting said diaphragm.

8. The hearing aid as set forth in claim 7, wherein said magnets and said upright support portions for supporting said diaphragm are disposed in the same circumference of a circle.

9. The hearing aid as set forth in claim 7, wherein: said bone conduction speaker has said diaphragm; said diaphragm is provided with a central opening in its central portion, said central opening being elongated in its lateral direction; and, a plate yoke is fixedly mounted on said diaphragm and capable of vibrating within said central opening.

10. The hearing aid as set forth in claim 9, wherein: in said bone conduction speaker, said plate yoke is fixedly mounted on an upper surface of a housing when said plate yoke is incorporated in said housing.
